(19) United States
(12) Patent Application Publication
(10) Pub. No.: US 2025/0317653 A1
(43) Pub. Date: Oct. 9, 2025

(54) METHODS FOR CAPTURING CONTENT

(71) Applicant: Apple Inc., Cupertino, CA (US)

(72) Inventors: Onur E. TACKIN, Saratoga, CA (US); Cahya A. MASPUTRA, San Jose, CA (US); Dhruv SAMANT, San Francisco, CA (US); Shilpa A. GEORGE, Cupertino, CA (US); Junjue WANG, Newark, CA (US); Ranjit DESAI, Cupertino, CA (US); Najeeb M. ABDULRAHIMAN, Fremont, CA (US)

(21) Appl. No.: 19/045,815

(22) Filed: Feb. 5, 2025

Related U.S. Application Data
(60) Provisional application No. 63/575,480, filed on Apr. 5, 2024.

(51) Int. Cl. H04N 23/695; H04N 23/661

(52) U.S. Cl. CPC H04N 23/695; H04N 23/661

(57) ABSTRACT

The present disclosure generally relates to capturing content. Some techniques are described herein for physically moving a camera to capture a static representation of an environment. In such techniques, the static representation can be performed once for a video call so that video for the video call and the static representation can be combined to provide a greater field-of-view for a recipient. Other techniques are described herein for directing a camera towards different subjects. In such techniques, the camera can be directed towards a primary subject during content capture and, in response to a gaze of the primary subject satisfying a set of criteria with respect to another subject, the camera can be directed towards the other object.

### CROSS-REFERENCE TO RELATED APPLICATIONS

The present application claims priority to U.S. Provisional Patent Application Ser. No. 63/575,480, entitled “METHODS FOR CAPTURING CONTENT,” filed Apr. 5, 2024, which is hereby incorporated by reference in its entirety for all purposes.

### BACKGROUND

Electronic devices are increasing being used for capturing content. For example, electronic devices are often used for video calls and recording videos. Managing capture of this content has become increasingly more difficult as electronic devices have become more varied and capabilities more expansive. Accordingly, there is a need to improve techniques for capturing content.

### SUMMARY

Current techniques for capturing content are generally ineffective and/or inefficient. For example, some techniques limit the field-of-view of content and/or require users to physically move devices to capture different fields of view. This disclosure provides more effective and/or efficient techniques for capturing content using examples of moving a smart phone automatically. It should be recognized that other types of electronic devices can be used with techniques described herein. For example, a movable mount and/or a head mounted display device can use techniques described herein. In addition, techniques optionally complement or replace other techniques for capturing content.

Some techniques are described herein for physically moving a camera on a moveable mount (and/or compute system) on a moveable mount to capture a static representation of an environment. In such techniques, the static representation can be performed once for a video call so that video for the video call and the static representation can be combined to provide a greater field-of-view for a recipient. In some embodiments, the static representation is sent by a sending device separately from the video call so that a receiving device can combine the static representation with the video call as the receiving device receives the video call. In other embodiments, the sending device combines the static representation and the video call so to send the combined frame to the receiving device as the video call. Other techniques are described herein for directing a camera towards different subjects. In such techniques, the camera can be directed towards a primary subject during content capture and, in response to a gaze of the primary subject satisfying a set of criteria with respect to another subject, the camera can be directed towards the other object.

In some embodiments, a method that is performed at a first computer system that is in communication with a movement component, and one or more cameras is described. In some embodiments, the method comprises: connecting to a second computer system, different from the first computer system, via a communication session; in conjunction with connecting to the second computer system via the communication session: physically moving, via the movement component, a camera of the one or more cameras; and while physically moving the camera, capturing, via the one or more cameras, a first representation of a portion of an environment; and after capturing the first representation of the portion of the environment, sending, to the second computer system via the communication session, a second representation of the portion of the environment, wherein the second representation is based on the first representation of the portion of the environment, and wherein the second representation is different from the first representation.

In some embodiments, a non-transitory computer-readable storage medium storing one or more programs configured to be executed by one or more processors of a first computer system that is in communication with a movement component, and one or more cameras is described. In some embodiments, the one or more programs includes instructions for: connecting to a second computer system, different from the first computer system, via a communication session; in conjunction with connecting to the second computer system via the communication session: physically moving, via the movement component, a camera of the one or more cameras; and while physically moving the camera, capturing, via the one or more cameras, a first representation of a portion of an environment; and after capturing the first representation of the portion of the environment, sending, to the second computer system via the communication session, a second representation of the portion of the environment, wherein the second representation is based on the first representation of the portion of the environment, and wherein the second representation is different from the first representation.

In some embodiments, a transitory computer-readable storage medium storing one or more programs configured to be executed by one or more processors of a first computer system that is in communication with a movement component, and one or more cameras is described. In some embodiments, the one or more programs includes instructions for: connecting to a second computer system, different from the first computer system, via a communication session; in conjunction with connecting to the second computer system via the communication session: physically moving, via the movement component, a camera of the one or more cameras; and while physically moving the camera, capturing, via the one or more cameras, a first representation of a portion of an environment; and after capturing the first representation of the portion of the environment, sending, to the second computer system via the communication session, a second representation of the portion of the environment, wherein the second representation is based on the first representation of the portion of the environment, and wherein the second representation is different from the first representation.

In some embodiments, a first computer system configured to communicate with a movement component, and one or more cameras is described. In some embodiments, the first computer system comprises one or more processors and memory storing one or more programs configured to be executed by the one or more processors. In some embodiments, the one or more programs includes instructions for: connecting to a second computer system, different from the first computer system, via a communication session; in conjunction with connecting to the second computer system via the communication session: physically moving, via the movement component, a camera of the one or more cameras; and while physically moving the camera, capturing, via the one or more cameras, a first representation of a portion of an environment; and after capturing the first representation of the portion of the environment, sending, to the second computer system via the communication session, a second representation of the portion of the environment, wherein the second representation is based on the first representation of the portion of the environment, and wherein the second representation is different from the first representation.

In some embodiments, a first computer system configured to communicate with a movement component, and one or more cameras is described. In some embodiments, the first computer system comprises means for performing each of the following steps: connecting to a second computer system, different from the first computer system, via a communication session; in conjunction with connecting to the second computer system via the communication session: physically moving, via the movement component, a camera of the one or more cameras; and while physically moving the camera, capturing, via the one or more cameras, a first representation of a portion of an environment; and after capturing the first representation of the portion of the environment, sending, to the second computer system via the communication session, a second representation of the portion of the environment, wherein the second representation is based on the first representation of the portion of the environment, and wherein the second representation is different from the first representation.

In some embodiments, a computer program product is described. In some embodiments, the computer program product comprises one or more programs configured to be executed by one or more processors of a first computer system that is in communication with a movement component, and one or more cameras. In some embodiments, the one or more programs include instructions for: connecting to a second computer system, different from the first computer system, via a communication session; in conjunction with connecting to the second computer system via the communication session: physically moving, via the movement component, a camera of the one or more cameras; and while physically moving the camera, capturing, via the one or more cameras, a first representation of a portion of an environment; and after capturing the first representation of the portion of the environment, sending, to the second computer system via the communication session, a second representation of the portion of the environment, wherein the second representation is based on the first representation of the portion of the environment, and wherein the second representation is different from the first representation.

In some embodiments, a method that is performed at a computer system that is in communication with a movement component, and one or more input devices is described. In some embodiments, the method comprises: while capturing, via the one or more input devices, media content: directing, via the movement component, the one or more input devices to a user; while directing the one or more input devices to the user, detecting, via the one or more input devices, a gaze of the user at a location; and in response to detecting the gaze of the user at the location: in accordance with a determination that the gaze of the user does not satisfy a set of one or more criteria, continuing to direct, via the movement component, the one or more input devices to the user; and in accordance with a determination that the gaze of the user satisfies the set of one or more criteria, directing the one or more input devices to the location.

In some embodiments, a non-transitory computer-readable storage medium storing one or more programs configured to be executed by one or more processors of a computer system that is in communication with a movement component, and one or more input devices is described. In some embodiments, the one or more programs includes instructions for: while capturing, via the one or more input devices, media content: directing, via the movement component, the one or more input devices to a user; while directing the one or more input devices to the user, detecting, via the one or more input devices, a gaze of the user at a location; and in response to detecting the gaze of the user at the location: in accordance with a determination that the gaze of the user does not satisfy a set of one or more criteria, continuing to direct, via the movement component, the one or more input devices to the user; and in accordance with a determination that the gaze of the user satisfies the set of one or more criteria, directing the one or more input devices to the location.

In some embodiments, a transitory computer-readable storage medium storing one or more programs configured to be executed by one or more processors of a computer system that is in communication with a movement component, and one or more input devices is described. In some embodiments, the one or more programs includes instructions for: while capturing, via the one or more input devices, media content: directing, via the movement component, the one or more input devices to a user; while directing the one or more input devices to the user, detecting, via the one or more input devices, a gaze of the user at a location; and in response to detecting the gaze of the user at the location: in accordance with a determination that the gaze of the user does not satisfy a set of one or more criteria, continuing to direct, via the movement component, the one or more input devices to the user; and in accordance with a determination that the gaze of the user satisfies the set of one or more criteria, directing the one or more input devices to the location.

In some embodiments, a computer system configured to communicate with a movement component, and one or more input devices is described. In some embodiments, the computer system comprises one or more processors and memory storing one or more programs configured to be executed by the one or more processors. In some embodiments, the one or more programs includes instructions for: while capturing, via the one or more input devices, media content: directing, via the movement component, the one or more input devices to a user; while directing the one or more input devices to the user, detecting, via the one or more input devices, a gaze of the user at a location; and in response to detecting the gaze of the user at the location: in accordance with a determination that the gaze of the user does not satisfy a set of one or more criteria, continuing to direct, via the movement component, the one or more input devices to the user; and in accordance with a determination that the gaze of the user satisfies the set of one or more criteria, directing the one or more input devices to the location.

In some embodiments, a computer system configured to communicate with a movement component, and one or more input devices is described. In some embodiments, the computer system comprises means for performing each of the following steps: while capturing, via the one or more input devices, media content: directing, via the movement component, the one or more input devices to a user; while directing the one or more input devices to the user, detecting, via the one or more input devices, a gaze of the user at a location; and in response to detecting the gaze of the user at the location: in accordance with a determination that the gaze of the user does not satisfy a set of one or more criteria, continuing to direct, via the movement component, the one or more input devices to the user; and in accordance with a determination that the gaze of the user satisfies the set of one or more criteria, directing the one or more input devices to the location.

In some embodiments, a computer program product is described. In some embodiments, the computer program product comprises one or more programs configured to be executed by one or more processors of a computer system that is in communication with a movement component, and one or more input devices. In some embodiments, the one or more programs include instructions for: while capturing, via the one or more input devices, media content: directing, via the movement component, the one or more input devices to a user; while directing the one or more input devices to the user, detecting, via the one or more input devices, a gaze of the user at a location; and in response to detecting the gaze of the user at the location: in accordance with a determination that the gaze of the user does not satisfy a set of one or more criteria, continuing to direct, via the movement component, the one or more input devices to the user; and in accordance with a determination that the gaze of the user satisfies the set of one or more criteria, directing the one or more input devices to the location.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 is a block diagram illustrating a compute system in accordance with some embodiments.

FIG. 2 is a block diagram illustrating a device with interconnected subsystems in accordance with some embodiments.

FIGS. 3A-3D illustrate exemplary user interfaces for capturing content in accordance with some embodiments.

FIG. 4 is a flow diagram illustrating a method for capturing content in accordance with some embodiments.

FIGS. 5A-5E illustrate exemplary user interfaces for capturing content while moving in accordance with some embodiments.

FIG. 6 is a flow diagram illustrating a method for capturing content while moving in accordance with some embodiments.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

Methods described herein can include one or more steps that are contingent upon one or more conditions being satisfied. It should be understood that a method can occur over multiple iterations of the same process with different steps of the method being satisfied in different iterations. For example, if a method requires performing a first step upon a determination that a set of one or more criteria is met and a second step upon a determination that the set of one or more criteria is not met, a person of ordinary skill in the art would appreciate that the steps of the method are repeated until both conditions, in no particular order, are satisfied. Thus, a method described with steps that are contingent upon a condition being satisfied can be rewritten as a method that is repeated until each of the conditions described in the method are satisfied. This, however, is not required of system or computer readable medium claims where the system or computer readable medium claims include instructions for performing one or more steps that are contingent upon one or more conditions being satisfied. Because the instructions for the system or computer readable medium claims are stored in one or more processors and/or at one or more memory locations, the system or computer readable medium claims include logic that can determine whether the one or more conditions have been satisfied without explicitly repeating steps of a method until all of the conditions upon which steps in the method are contingent have been satisfied. A person having ordinary skill in the art would also understand that, similar to a method with contingent steps, a system or computer readable storage medium can repeat the steps of a method as many times as needed to ensure that all of the contingent steps have been performed.

Although the following description uses terms “first,” “second,” etc. to describe various elements, these elements should not be limited by the terms. In some examples, these terms are used to distinguish one element from another. For example, a first subsystem could be termed a second subsystem, and, similarly, a second subsystem device or a subsystem device could be termed a first subsystem device, without departing from the scope of the various described embodiments. In some examples, the first subsystem and the second subsystem are two separate references to the same subsystem. In some examples, the first subsystem and the second subsystem are both subsystems, but they are not the same subsystem or the same type of subsystem.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

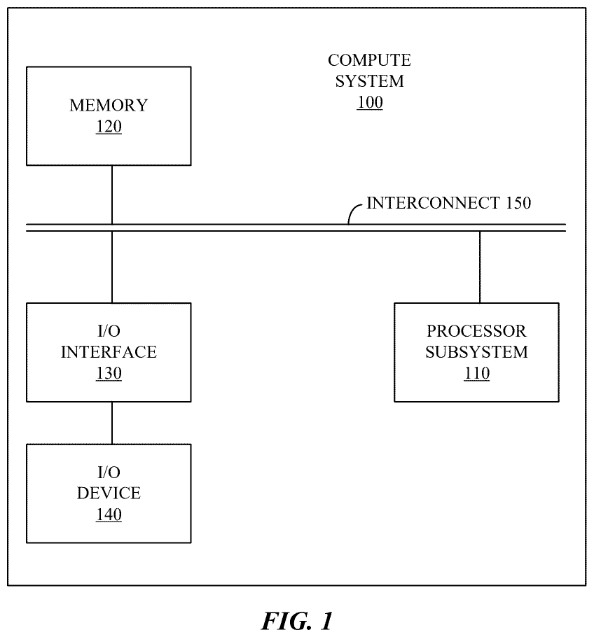

Turning to FIG. 1, a block diagram of compute system 100 is illustrated. Compute system 100 is a non-limiting example of a compute system that can be used to perform functionality described herein. It should be recognized that other computer architectures of a compute system can be used to perform functionality described herein.

In the illustrated example, compute system 100 includes processor subsystem 110 communicating with (e.g., wired or wirelessly) memory 120 (e.g., a system memory) and I/O interface 130 via interconnect 150 (e.g., a system bus, one or more memory locations, or other communication channel for connecting multiple components of compute system 100). In addition, I/O interface 130 is communicating with (e.g., wired or wirelessly) to I/O device 140. In some examples, I/O interface 130 is included with I/O device 140 such that the two are a single component. It should be recognized that there can be one or more I/O interfaces, with each I/O interface communicating with one or more I/O devices. In some examples, multiple instances of processor subsystem 110 can be communicating via interconnect 150.

Compute system 100 can be any of various types of devices, including, but not limited to, a system on a chip, a server system, a personal computer system (e.g., a smartphone, a smartwatch, a wearable device, a tablet, a laptop computer, and/or a desktop computer), a sensor, or the like. In some examples, compute system 100 is included or communicating with a physical component for the purpose of modifying the physical component in response to an instruction. In some examples, compute system 100 receives an instruction to modify a physical component and, in response to the instruction, causes the physical component to be modified. In some examples, the physical component is modified via an actuator, an electric signal, and/or algorithm. Examples of such physical components include an acceleration control, a break, a gear box, a hinge, a motor, a pump, a refrigeration system, a spring, a suspension system, a steering control, a pump, a vacuum system, and/or a valve. In some examples, a sensor includes one or more hardware components that detect information about a physical environment in proximity to (e.g., surrounding) the sensor. In some examples, a hardware component of a sensor includes a sensing component (e.g., an image sensor or temperature sensor), a transmitting component (e.g., a laser or radio transmitter), a receiving component (e.g., a laser or radio receiver), or any combination thereof. Examples of sensors include an angle sensor, a chemical sensor, a brake pressure sensor, a contact sensor, a non-contact sensor, an electrical sensor, a flow sensor, a force sensor, a gas sensor, a humidity sensor, an image sensor (e.g., a camera sensor, a radar sensor, and/or a LiDAR sensor), an inertial measurement unit, a leak sensor, a level sensor, a light detection and ranging system, a metal sensor, a motion sensor, a particle sensor, a photoelectric sensor, a position sensor (e.g., a global positioning system), a precipitation sensor, a pressure sensor, a proximity sensor, a radio detection and ranging system, a radiation sensor, a speed sensor (e.g., measures the speed of an object), a temperature sensor, a time-of-flight sensor, a torque sensor, and an ultrasonic sensor. In some examples, a sensor includes a combination of multiple sensors. In some examples, sensor data is captured by fusing data from one sensor with data from one or more other sensors. Although a single compute system is shown in FIG. 1, compute system 100 can also be implemented as two or more compute systems operating together.

In some examples, processor subsystem 110 includes one or more processors or processing units configured to execute program instructions to perform functionality described herein. For example, processor subsystem 110 can execute an operating system, a middleware system, one or more applications, or any combination thereof.

In some examples, the operating system manages resources of compute system 100. Examples of types of operating systems covered herein include batch operating systems (e.g., Multiple Virtual Storage (MVS)), time-sharing operating systems (e.g., Unix), distributed operating systems (e.g., Advanced Interactive eXecutive (AIX), network operating systems (e.g., Microsoft Windows Server), and real-time operating systems (e.g., QNX). In some examples, the operating system includes various procedures, sets of instructions, software components, and/or drivers for controlling and managing general system tasks (e.g., memory management, storage device control, power management, or the like) and for facilitating communication between various hardware and software components. In some examples, the operating system uses a priority-based scheduler that assigns a priority to different tasks that processor subsystem 110 can execute. In such examples, the priority assigned to a task is used to identify a next task to execute. In some examples, the priority-based scheduler identifies a next task to execute when a previous task finishes executing. In some examples, the highest priority task runs to completion unless another higher priority task is made ready.

In some examples, the middleware system provides one or more services and/or capabilities to applications (e.g., the one or more applications running on processor subsystem 110) outside of what the operating system offers (e.g., data management, application services, messaging, authentication, API management, or the like). In some examples, the middleware system is designed for a heterogeneous computer cluster to provide hardware abstraction, low-level device control, implementation of commonly used functionality, message-passing between processes, package management, or any combination thereof. Examples of middleware systems include Lightweight Communications and Marshalling (LCM), PX4, Robot Operating System (ROS), and ZeroMQ. In some examples, the middleware system represents processes and/or operations using a graph architecture, where processing takes place in nodes that can receive, post, and multiplex sensor data messages, control messages, state messages, planning messages, actuator messages, and other messages. In such examples, the graph architecture can define an application (e.g., an application executing on processor subsystem 110 as described above) such that different operations of the application are included with different nodes in the graph architecture.

In some examples, a message sent from a first node in a graph architecture to a second node in the graph architecture is performed using a publish-subscribe model, where the first node publishes data on a channel in which the second node can subscribe. In such examples, the first node can store data in memory (e.g., memory 120 or some local memory of processor subsystem 110) and notify the second node that the data has been stored in the memory. In some examples, the first node notifies the second node that the data has been stored in the memory by sending a pointer (e.g., a memory pointer, such as an identification of a memory location) to the second node so that the second node can access the data from where the first node stored the data. In some examples, the first node would send the data directly to the second node so that the second node would not need to access a memory based on data received from the first node.

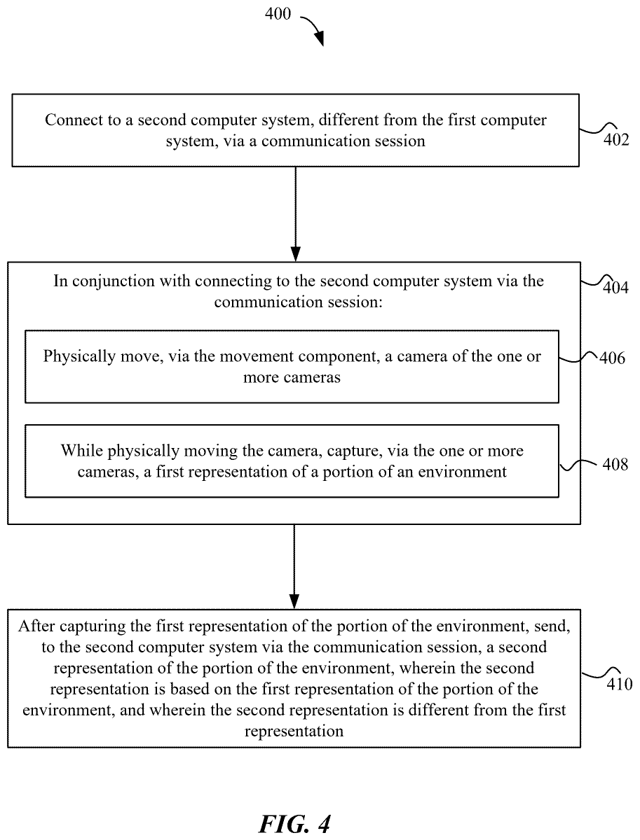

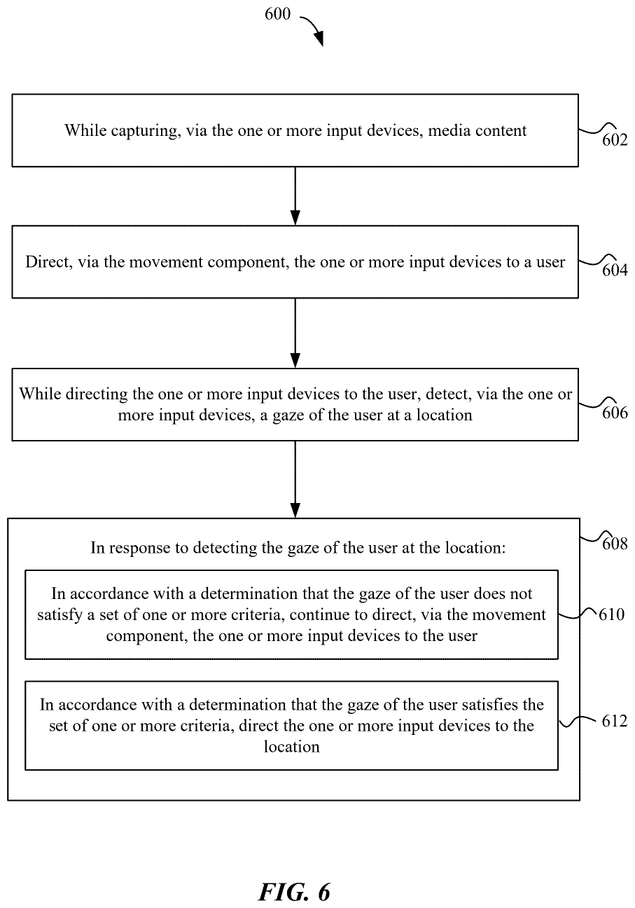

Memory 120 can include a computer readable medium (e.g., non-transitory or transitory computer readable medium) usable to store (e.g., configured to store, assigned to store, and/or that stores) program instructions executable by processor subsystem 110 to cause compute system 100 to perform various operations described herein. For example, memory 120 can store program instructions to implement the functionality associated with methods 400 and 600 (FIGS. 4 and 6) described below.

Memory 120 can be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, or the like), read only memory (PROM, EEPROM, or the like), or the like. Memory in compute system 100 is not limited to primary storage such as memory 120. Compute system 100 can also include other forms of storage such as cache memory in processor subsystem 110 and secondary storage on I/O device 140 (e.g., a hard drive, storage array, etc.). In some examples, these other forms of storage can also store program instructions executable by processor subsystem 110 to perform operations described herein. In some examples, processor subsystem 110 (or each processor within processor subsystem 110) contains a cache or other form of on-board memory.

I/O interface 130 can be any of various types of interfaces configured to communicate with other devices. In some examples, I/O interface 130 includes a bridge chip (e.g., Southbridge) from a front-side bus to one or more back-side buses. I/O interface 130 can communicate with one or more I/O devices (e.g., I/O device 140) via one or more corresponding buses or other interfaces. Examples of I/O devices include storage devices (hard drive, optical drive, removable flash drive, storage array, SAN, or their associated controller), network interface devices (e.g., to a local or wide-area network), sensor devices (e.g., camera, radar, LiDAR, ultrasonic sensor, GPS, inertial measurement device, or the like), and auditory or visual output devices (e.g., speaker, light, screen, projector, or the like). In some examples, compute system 100 is communicating with a network via a network interface device (e.g., configured to communicate over Wi-Fi, Bluetooth, Ethernet, or the like). In some examples, compute system 100 is directly or wired to the network.

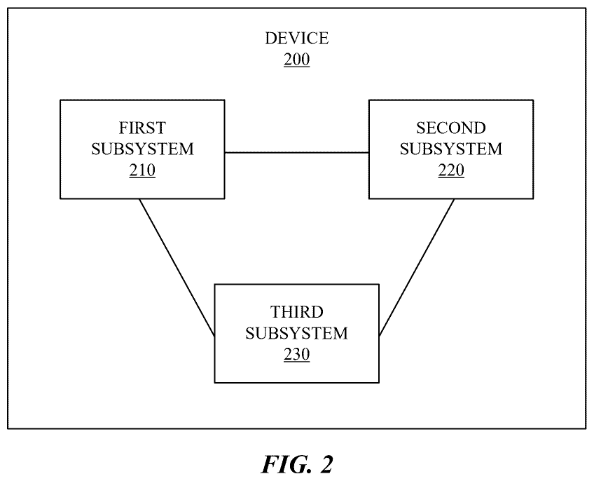

FIG. 2 illustrates a block diagram of device 200 with interconnected subsystems. In the illustrated example, device 200 includes three different subsystems (i.e., first subsystem 210, second subsystem 220, and third subsystem 230) communicating with (e.g., wired or wirelessly) each other, creating a network (e.g., a personal area network, a local area network, a wireless local area network, a metropolitan area network, a wide area network, a storage area network, a virtual private network, an enterprise internal private network, a campus area network, a system area network, and/or a controller area network). An example of a possible computer architecture of a subsystem as included in FIG. 2 is described in FIG. 1 (i.e., compute system 100). Although three subsystems are shown in FIG. 2, device 200 can include more or fewer subsystems.

In some examples, some subsystems are not connected to other subsystem (e.g., first subsystem 210 can be connected to second subsystem 220 and third subsystem 230 but second subsystem 220 cannot be connected to third subsystem 230). In some examples, some subsystems are connected via one or more wires while other subsystems are wirelessly connected. In some examples, messages are set between the first subsystem 210, second subsystem 220, and third subsystem 230, such that when a respective subsystem sends a message the other subsystems receive the message (e.g., via a wire and/or a bus). In some examples, one or more subsystems are wirelessly connected to one or more compute systems outside of device 200, such as a server system. In such examples, the subsystem can be configured to communicate wirelessly to the one or more compute systems outside of device 200.

In some examples, device 200 includes a housing that fully or partially encloses subsystems 210-230. Examples of device 200 include a home-appliance device (e.g., a refrigerator or an air conditioning system), a robot (e.g., a robotic arm or a robotic vacuum), and a vehicle. In some examples, device 200 is configured to navigate (with or without user input) in a physical environment.

In some examples, one or more subsystems of device 200 are used to control, manage, and/or receive data from one or more other subsystems of device 200 and/or one or more compute systems remote from device 200. For example, first subsystem 210 and second subsystem 220 can each be a camera that captures images, and third subsystem 230 can use the captured images for decision making. In some examples, at least a portion of device 200 functions as a distributed compute system. For example, a task can be split into different portions, where a first portion is executed by first subsystem 210 and a second portion is executed by second subsystem 220.

Attention is now directed towards techniques for capturing content. Such techniques are described in the context of a smart phone connecting with a head mounted display (HMD) device. It should be recognized that other types of electronic devices can be used with techniques described herein. For example, a HMD device may connect with another HMD device using techniques described herein. In addition, techniques optionally complement or replace other techniques for connecting devices.

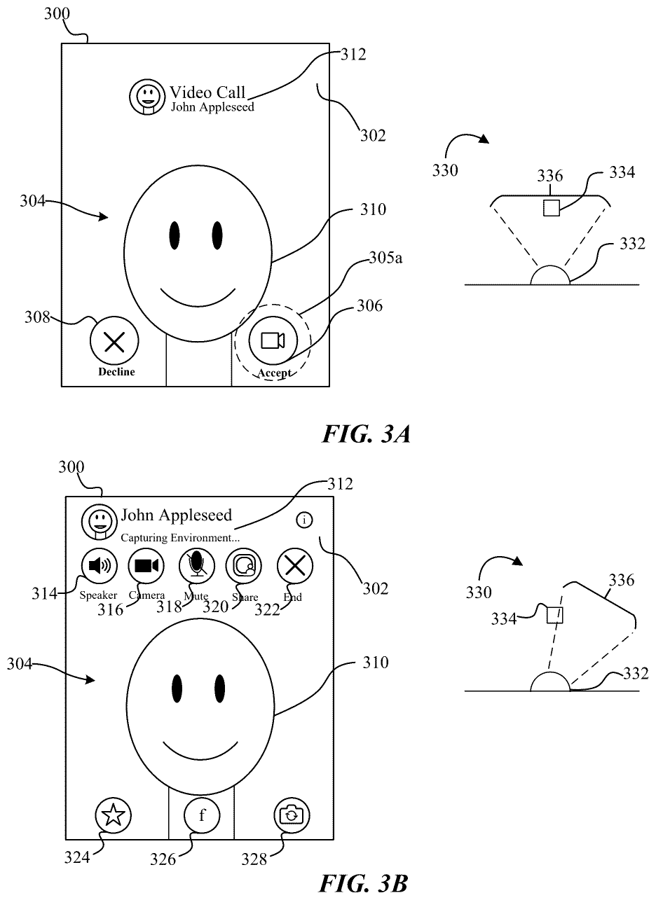

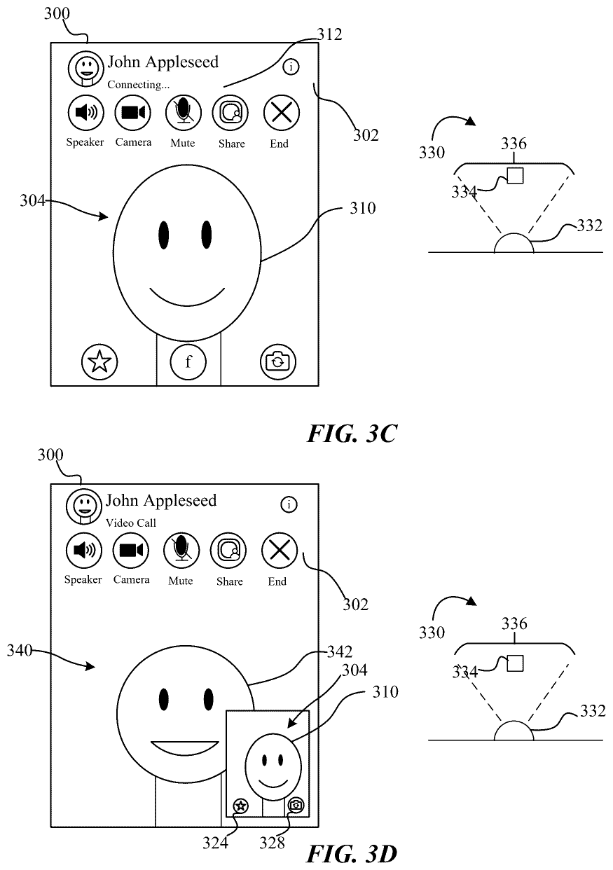

FIGS. 3A-3D illustrate exemplary user interfaces for capturing content using a computer system in accordance with some embodiments. The user interfaces in these figures are used to illustrate the processes described below, including the processes in FIG. 4.

The left side of FIGS. 3A-3D illustrate computer system 300 as a smart phone. It should be recognized that computer system 300 can be other types of computer systems, such as a tablet, a smart watch, a laptop, communal device, a smart speaker, a personal gaming system, a desktop computer, a fitness tracking device, and/or a head-mounted display (HMD) device. In some embodiments, computer system 300 includes and/or is in communication with one or more input devices (e.g., a camera, a depth sensor, a microphone, a hardware input mechanism, a rotatable input mechanism, a heart monitor, a temperature sensor, and/or a touch-sensitive surface). In some embodiments, computer system 300 includes and/or is in communication with one or more output devices (e.g., a display component (e.g., a display screen, a projector, and/or a touch-sensitive display), an audio component (e.g., smart speaker, home theater system, soundbar, headphone, earphone, earbud, speaker, television speaker, augmented reality headset speaker, audio jack, optical audio output, Bluetooth audio output, and/or HDMI audio output), a speaker, a haptic output device, a display screen, a projector, and/or a touch-sensitive display)).

The right side of FIGS. 3A-3D illustrate different positions of computer system 300 within physical environment 330. Physical environment 330 includes device representation 332 (which represents a location of computer system 300 within physical environment 330) and user representation 334 (which represents a location of user 310 within physical environment 330). As illustrated in FIGS. 3A-3D, physical environment 330 also includes field-of-view 336, which represents an orientation of computer system 300 within physical environment 330. In some embodiments, field-of-view 336 represents a field-of-view of a camera of computer system 300.

As illustrated in FIGS. 3A-3D, computer system 300 displays user interface 302. In some embodiments, user interface 302 is a user interface displayed by computer system 300 when computer system 300 receives a video call. In some embodiments, user interface 302 is displayed in response to computer system 300 detecting a request to establish a video call. It should be recognized that user interface 302 is just one example of a user interface used with techniques described herein and that other types of user interfaces can also be used.

As illustrated in FIGS. 3A-3D, user interface 302 includes live view 304. In some embodiments, live view 304 is a representation (e.g., an image or a video) of physical environment 330 as captured by the camera. As illustrated in FIGS. 3A-3D, the representation includes user 310. As illustrated in FIGS. 3A-3C, live view 304 is displayed by computer system 300 in a center position of user interface 302. As illustrated in FIG. 3D, live view 304 is displayed by computer system 300 in a corner of user interface 302. In some embodiments, live view 304 is displayed by computer system 300 across the entirety of user interface 302. In some embodiments, live view 304 is displayed by computer system 300 on the bottom or top of user interface 302.

At FIG. 3A, computer system 300 receives a video call from a device of John Appleseed as indicated by call status indication 312. In some embodiments, the device of John Appleseed includes a camera. In some embodiments, when the device of John Appleseed sends the video call to computer system 300, the device sends media captured by the camera of the device of John Appleseed.

As illustrated in FIG. 3A, user representation 334 is in field-of-view 336 in physical environment 330. At FIG. 3A, computer system 300 captures and displays user 310 within live view 304. In some embodiments, computer system 300 displays user 310 within live view 304 and not another object or user in the environment. For example, computer system 300 identifies user 310 and determines that there is not another user in physical environment 330. Based on the determination, computer system 300 can identify user 310 as the primary subject in physical environment 330 (e.g., because user 310 is the only person in the view) and modify the field-of-view of the camera (e.g., by physically moving the camera, as further described below) based on user 310 being identified as the primary subject in field-of-view 336.

In some embodiments, live view 304 includes other aspects of physical environment 330 within field-of-view 336, including walls and/or objects in physical environment 330. For example, in some embodiments, behind user representation 334 is a bookcase. In this example, live view 304 includes the bookcase because the bookcase is behind user representation 334 but within field-of-view 336.

As also illustrated in FIG. 3A, user interface 302 includes accept control 306 and decline control 308 in the bottom of user interface 302. As illustrated in FIG. 3A, accept control 306 and decline control 308 are displayed concurrently with and on top of (e.g., overlapping) at least a portion of live view 304. In some embodiments, in response to detecting an input directed to decline control 308, computer system 300 declines the video call. In some embodiments, in response to declining the video call, computer system 300 ceases display of user interface 302. In some embodiments, after computer system 300 ceases display of user interface 302 in response to declining the video call, computer system 300 displays another user interface, such as a home screen user interface or a lock screen.

At FIG. 3A, computer system 300 detects tap input 305a on accept control 306. In some embodiments, tap input 305a is received from user 310. It should be recognized that a tap input is just one example of a type of input that can be used with techniques described herein and that other types of input can be used, such as a voice input detected via microphone (e.g., “Accept the call”), and/or an air gesture detected via the camera of computer system 300. Although the above describes detecting tap input 305a on accept control 306 to accept an incoming call, in some embodiments, computer system 300 detects a tap input on a user interface element to initiate an outgoing call. For example, computer system 300 detects a tap input on a person's name displayed by computer system 300 to initiate one or more processes described below, such as illustrated in FIGS. 3B-3D.

After FIG. 3A, in response to detecting tap input 305a on accept control 306, computer system 300 initiates capture of different portions of physical environment 330. In some embodiments, the static representation of physical environment 330 is generated after and/or while capturing physical environment 330. In some embodiments, the different portions of physical environment 330 are captured to create a static representation (e.g., a 3D and/or 2D model) of physical environment 330 for sending to the device of John Appleseed. In such embodiments, the static representation can include or be different from live view 304. In some embodiments, the static representation of physical environment 330 includes multiple portions of physical environment 330 to represent physical environment 330. For example, the static representation of physical environment 330 includes a plurality of photos aligned together to represent physical environment 330. Stated differently, in some embodiments, computer system 300 captures the static representation of physical environment 330 by capturing a series of photos and/or video of physical environment 330. For example, computer system 300 uses many different perspectives and many different portions of physical environment 300 to generate the static representation of physical environment 330. In some embodiments, the static representation of physical environment 330 includes computer generated objects representing physical environment 330. For example, computer system 300 generates the computer-generated objects from the capture of the different portions of the physical environment. In another example, computer system 300 captures physical environment 330 using remote sensing systems (e.g., LIDAR). In another example, computer system 300 captures physical environment 330 using media captured by the camera and generates the static representation of physical environment 330 by determining depth of various features in physical environment 330.

In some embodiments, the static representation of physical environment 330 includes portions of physical environment 330 that are determined to be static and/or not include the primary subject in physical environment 330 (referred to as the static portions of environment 330). In some embodiments, the static portions of physical environment 330 include objects in the environment not determined likely to move during the video call. For example, the objects in the environment determined not likely to move include furniture, decor, walls, and televisions. In some embodiments, while or after capturing the static representation of physical environment 330, computer system 300 removes live and/or non-static objects from the static representation of physical environment 330.

In some embodiments, computer system 300 pans, tilts, moves, and/or rotates the camera (and/or a portion of computer system 300) to capture a portion of and/or the entirety of physical environment 330. For example, computer system 300 can cause field-of-view 336 to be moved by activating a component of computer system 300, such as an actuator that is part of computer system 300, where movement of the actuator causes field-of-view 336 to be changed and/or shifted. In such an example, the actuator can move a portion of computer system 300 that includes the camera to a different direction and/or to be oriented differently so that field-of-view 336 is changed. For another example, computer system 300 can cause field-of-view 336 to be moved by activating a component remote and/or separate from computer system 300, such as an actuator of a mount physically and/or magnetically coupled to computer system 300. In such an example, computer system 300 can be in communication with the mount and controlling a position of the mount by sending control messages to the mount. It should be recognized that other techniques known by a person of ordinary skill in the art can be used in addition to or instead of techniques described above to result in moving field-of-view 336.

In some embodiments, computer system 300 moves, using the techniques described above, to capture the entirety of physical environment 330 by physically moving to capture portions of physical environment 330 not within field-of-view 336. For example, computer system 300 rotates 360 degrees to capture physical environment 330. Such movement allows computer system 300 to capture a larger portion of physical environment 330 than would be possible without moving. For example, because computer system 300 rotates to capture a larger portion of physical environment 330, computer system 300 captures portions of physical environment 330 that are outside of field-of-view 336 in a stationary location. In another example, while computer system 300 is capturing physical environment 330, computer system 300 determines there is an obstruction blocking the capture of portions of physical environment 330. For example, computer system 300 determines a pillar blocks the capture of a couch behind the pillar from the camera's perspective. In some embodiments, computer system 300 moves to a position that is no longer blocked by the obstruction and captures the missing portion of physical environment 330. For example, computer system 300 moves to a position around the pillar that blocked the capture of the couch. In another example, computer system 300 detects a gap in the static representation of physical environment 330 (e.g., around a corner). In this example, computer system 30 moves to a position (e.g., around the corner) to capture the entirety of physical environment 330.

Although the above and below description discusses the entirety of physical environment 330 being included in the static representation, in some embodiments, only a portion of physical environment 330 is included in the static representation. For example, computer system 300 is stationary and cannot pan, tilt, move, and/or rotate. For another example, computer system 300 only includes portions outside of a portion including the primary subject and/or outside of a field of view including the primary subject in the static representation. For another example, computer system 300 only includes portions in a certain area of physical environment 330, such as defined by a user of computer system 300. In some embodiments, computer system 300 causes field-of-view 336 to be moved by performing a software-based operation that changes field-of-view 336 without physically moving the camera. For example, the camera can capture a larger field-of-view than illustrated in live view 304. In such an example, live view 304 in FIG. 3A and/or FIG. 3B can be the result of cropping field-of-view 336 captured by the camera. It should be recognized that other software-based operations known by a person of ordinary skill in the art can be performed to change field-of-view 336.

In some embodiments, the static representation of physical environment 330 is captured to provide to the device of John Appleseed. In some embodiments, the device of John Appleseed controls computer system 300 to move in physical environment 330. For example, the device of John Appleseed is a HMD device, and, during the video call, the HMD device is moved in its own environment to request to look around physical environment 330. Because the device of John Appleseed received the static representation of physical environment 330, computer system 300 does not move when the device of John Appleseed requests to look around physical environment 330. Instead, the device of John Appleseed uses the static representation of physical environment 330 to present different perspectives of physical environment 330. In some embodiments, movement of the device of John Appleseed is translates to movement of computer system 300. For example, as the device of John Appleseed looks to the left, computer system 300 rotates field of view 336 to the left of physical environment 330 accordingly. In some embodiments, computer system 300 is unable to rotate at the same speed as the device of John Appleseed, and the static representation of physical environment 330 is shown to John Appleseed until and before computer system 300 catches up to the movement with the camera of computer system 300.

Although the above and below description discusses capturing physical environment 330 and generating the static representation before connecting the video call to the device of John Appleseed, in some embodiments, computer system 300 captures physical environment 330 and/or generates the static representation at different points in time. For example, computer system 300 can capture physical environment 330 at a time before the video call was received. For example, computer system 300 can capture physical environment 330 and/or generate the static representation with respect to (e.g., before and/or during) a different video call. In such an example, computer system 300 uses the static representation of physical environment 330 from the previous video call for the video call with the device of John Appleseed. For another example, computer system 300 can generate the static representation while on the video call and, after generating, send the static representation to the device of John Appleseed. For another example, computer system 300 can periodically capture, such as after a certain amount of time since the last time physical environment 330 was captured, physical environment 330 to keep the static representation up to date. In some embodiments, computer system 300 captured physical environment 330 and/or generates the static representation only when receiving or making certain calls with certain devices. For example, computer system 300 can generate the static representation before making a video call to a device that is a HMD device.

As illustrated in FIG. 3B, field-of-view 336 is rotated to the right as compared to FIG. 3A while user representation 334 is in the same location as illustrated in FIG. 3A. In some embodiments, field-of-view 336 is rotated to the right as a result of computer system 300 moving the camera to the right. As described above, computer system 300 moves the camera to the right to scan additional portions of physical environment 330.

As illustrated in FIG. 3B, in response to detecting tap input 305a on accept control 306, computer system 300 updates display of call status indication 312 to indicate computer system 300 is capturing physical environment 300 (e.g., “Capturing Environment . . . ”) while continuing to display live view 304 and call status indication 312 in user interface 302. As illustrated in FIG. 3B, below call status indication 312, user interface 302 includes controls for the video call including speaker control 314, camera control 316, mute control 318, share control 320, and end control 322. As illustrated in FIG. 3B, at the bottom of user interface 302, user interface 302 includes additional controls for the video call including camera control 324, focus control 326, and change camera control 328. At FIG. 3B, computer system 300 ceases display of accept control 306 and decline control 308 in response to detecting tap input 305a.

Comparing the right side of FIG. 3B to left side of FIG. 3B, computer system 300 includes user 310 in the center of user interface 302 even though field-of-view 336 rotated in physical environment 330. In some embodiments, computer system 300 continues to capture user 310 with a different camera than the camera that is being rotated to change field-of-view 336 on the right of FIG. 3B. In some embodiments, computer system 300 rotated the same camera (or a different camera in the same motion) and partially captures user representation 334 (e.g., user 310) and user 310 is displayed on the left in FIG. 3B partially off the screen of live view 304. In other embodiments, live view 304 is not displayed while computer system 300 captures physical environment 330 and/or rotates the camera including field-of-view 336 away from user representation 334. In some embodiments, computer system 300 does not return user 310 to the center of live view 304 until field-of-view 336 is centered on user representation 334.

At FIG. 3C, in response to computer system 300 completing capture of physical environment 330 (and/or generation of the static representation), computer system 300 initiates the video call with the device of John Appleseed. As illustrated in FIG. 3C, computer system 300 continues to display user interface 302 including live view 304 that includes user 310. As illustrated in FIG. 3C, computer system 300 updates display of call status indication 312 to indicate computer system 300 is connecting the video call with the device of John Appleseed (e.g., “Connecting . . . ”).

As illustrated in FIG. 3C, device representation 332 returned field-of-view 336 to face user representation 334 as originally illustrated in FIG. 3A. At FIG. 3C, computer system 300 returned field-of-view 336 to face user representation 334 because computer system 300 has completed capturing physical environment 330. In some embodiments, computer system 300 returned field-of-view 336 to face user representation 334 to capture media of user 310 for the video call.

As illustrated in FIG. 3D, after computer system 300 returned field-of-view 336 to face user representation 334, computer system 300 commences the video call. In some embodiments, commencing the video call includes sending to the device of John Appleseed both the static representation of physical environment 330 and media captured by the camera. In some embodiments, the static representation of physical environment 330 is sent to the device of John Appleseed in order to provide portions of physical environment 330 that are static (e.g., as described above), obstructed (e.g., as described above) from computer system 300, and/or currently out of field of view 336. In some embodiments, computer system 300 captures the primary subject of the video call (e.g., user 310) during the video call and not other portions of physical environment 330. Stated differently, in some embodiments, computer system 300 sends the media captured by the camera that includes only a current field-of-view of the camera. In some embodiments, the device of John Appleseed uses both sets of data (e.g., the static representation of physical environment 330 and the media captured by the camera) (e.g., as described above) to generate a live view of physical environment 330 to be displayed by the device of John Appleseed. For example, after the device of John Appleseed receives the static representation of physical environment 330 and the media of physical environment 330 in field-of-view 336, the device of John Appleseed generates a live view using the media of physical environment 330 and/or the static representation and displays the live vie. In such an example, in response to the device of John Appleseed being moved to an orientation corresponding to an area outside of the media of physical environment 330 captured by field-of-view 336, the device of John Appleseed uses the static representation of physical environment 330 to generate and display a live view that includes at least a portion of the static representation (and, optionally, at least a portion of the media of physical environment 330 captured by field-of-view 336). In some embodiments, in response to the device of John Appleseed being moved to an orientation corresponding to an area outside of the media of physical environment 330 captured by field-of-view 336, computer system 300 moves the camera of computer system 300 to capture the area outside of the media of physical environment 330 while the device of John Appleseed displays the static representation. In other embodiments, in response to the device of John Appleseed being moved to an orientation corresponding to an area outside of the media of physical environment 330 captured by field-of-view 336, computer system 300 does not move the camera of computer system 300 and instead continues to capture first user 310. In such embodiments, the orientation corresponding to the area outside of the media of physical environment 330 captured by field-of-view 336 is displayed by the device of John Appleseed using the static representation without using the media of physical environment 330 captured by field-of-view 336.

In some embodiments, computer system 300 sends the static representation of physical environment 330 and the media captured by the camera to the device of John Appleseed via different transmission methods. For example, in some embodiments, the static representation of physical environment 300 and the media captured by the camera are sent using different communication channels and/or bit rates.

In some embodiments, computer system 300 continues sending the media captured by the camera without continuing to send the static representation. In other embodiments, computer system 300 continues to update the static representation and, as the static representation is updated, sends the static representation to the device of John Appleseed.

As illustrated in FIG. 3D, device representation 332 maintains field-of-view 336 facing user representation 334. In some embodiments, in response to detecting user 310 moving, computer system 300 moves to maintain user representation 334 in field-of-view 336 for the video call.

Also as illustrated in FIG. 3D, computer system 300 displays live view 304 in a different location of user interface 302. At FIG. 3D, computer system 300 displays live view 304 in the bottom right of user interface 302. As also illustrated in FIG. 3D, computer system 300 displays camera control 324 and change camera control 328 and ceases displaying focus control 326. In some embodiments, computer system 300 maintains display of live view 304 in the center of user interface 302 including camera control 324 and change camera control 328, and focus control 326 (e.g., as described above in FIG. 3B).

Also as illustrated in FIG. 3D, computer system 300 displays user interface 302 including live view 340. As illustrated in FIG. 3D, live view 340 includes a representation of John Appleseed 342. In some embodiments, live view 340 is received from the device of John Appleseed.

FIG. 4 is a flow diagram illustrating a method (e.g., method 400) for capturing content in accordance with some embodiments. Some operations in method 400 are, optionally, combined, the orders of some operations are, optionally, changed, and some operations are, optionally, omitted.

As described below, method 400 provides an intuitive way for capturing content. Method 400 reduces the cognitive burden on a user, thereby creating a more efficient human-machine interface. For battery-operated computing devices, enabling a user to interact with such devices faster and more efficiently conserves power and increases the time between battery charges.

In some embodiments, method 400 is performed at a first computer system (e.g., 300) that is in communication (e.g., wired communication and/or wireless communication) with a movement component (e.g., an actuator (e.g., a pneumatic actuator, hydraulic actuator and/or an electric actuator), a movable base, a rotatable component, a motor, a lift, a level, and/or a rotatable base), and one or more cameras (e.g., a telephoto, wide angle, and/or ultra-wide angle camera). In some embodiments, the computer system is in communication with one or more input devices (e.g., a depth sensor, a microphone, a hardware input mechanism, a rotatable input mechanism, a heart monitor, a temperature sensor, and/or a touch-sensitive surface). In some embodiments, the first computer system is a watch, a phone, a tablet, a fitness tracking device, a processor, a head-mounted display (HMD) device, a communal device, a media device, a speaker, a television, and/or a personal computing device.

The first computer system connects (402) to a second computer system (e.g., 300), different from the first computer system, via a communication session (e.g., as described above with respect to FIGS. 3A-3D) (e.g., call, video conference, and/or audio meeting). In some embodiments, the first computer system connects to the second computer system via the communication session in response to detecting, via the one or more input devices, the communication session. In some embodiments, the second computer system is a watch, a phone, a tablet, a fitness tracking device, a processor, a head-mounted display (HMD) device, a communal device, a media device, a speaker, a television, and/or a personal computing device. In some embodiments, the first computer system connects to the second computer system in response to detecting, via an input device (e.g., a camera, a depth sensor, a microphone, a hardware input mechanism, a rotatable input mechanism, a heart monitor, a temperature sensor, and/or a touch-sensitive surface) that is in communication with the first computer system, a request to connect to the second computer system.

In (404) conjunction (e.g., before, after, in response to, and/or while) with connecting to the second computer system (e.g., 300) via the communication session, the first computer system physically moves (406) (e.g., pan, tilt, rotate, and/or change physical position), via the movement component, a camera of the one or more cameras (e.g., as described above with respect to FIG. 3B). In some embodiments, in conjunction with connecting to the second computer system via the communication session, the first computer system physically moves, via the movement component, the one or more cameras.

In (404) conjunction with connecting to the second computer system via the communication session, while physically moving the camera, the first computer system (e.g., 300) captures (408), via the one or more cameras, a first representation (e.g., an image and/or mapping) of a portion of an environment (e.g., physical and/or virtual environment) (e.g., as described above with respect to FIG. 3B, the static representation of physical environment 330 and/or the media captured by the camera). In some embodiments, the first computer system physically moves the camera in a scanning motion to capture a portion of the environment larger than a portion of the environment captured by the camera staying stationary.

After (e.g., while and/or in response to) capturing the first representation of the portion of the environment (and/or after establishing the call), the first computer system sends (410), to the second computer system via the communication session, a second representation (e.g., a 3D model of static and/or background portions of the environment) of the portion of the environment, wherein the second representation is based on (e.g., a transformation of and/or includes removal of at least a portion (such as a portion including a user) of) the first representation of the portion of the environment, and wherein the second representation is different from (e.g., includes different content than) (e.g., not an encoded version of) the first representation (e.g., as described above with respect to FIGS. 3B and 3D, the static representation of physical environment 330 and/or the media captured by the camera). In some embodiments, the second representation of the portion of the environment is sent to the second computer system as part of the communication session.

In some embodiments, the first computer system (e.g., 300) is in communication with one or more input devices (e.g., a camera, a depth sensor, a microphone, a hardware input mechanism, a rotatable input mechanism, a heart monitor, a temperature sensor, and/or a touch-sensitive surface). In some embodiments, before connecting to the second computer system via the communication session, the first computer system detects, via the one or more input devices, an input (e.g., 305a) (e.g., a tap input and/or a non-tap input (e.g., a verbal input, an audible request, an audible command, an audible statement, a swipe input, a hold-and-drag input, a gaze input, an air gesture, mouse movement, and/or a mouse click)) corresponding to a request to connect (e.g., a cellular call, a Wi-Fi call, video conference, audio call, a social media audio call and/or video call) (e.g., establish the communication session between) the first computer system (e.g., 300) and the second computer system, wherein physically moving the camera of the one or more cameras occurs in response to detecting the input corresponding to the request to connect (e.g., as described above with respect to FIG. 3A). In some embodiments, the request to connect is a request to call a user corresponding to the second computer system.

In some embodiments, before connecting to the second computer system via the communication session, the first computer system detects (and/or receives) a request (e.g., 305a) to connect (e.g., a cellular call, a Wi-Fi call, video call, audio call, and/or a social media audio call and/or video call) (e.g., establish the communication session between) the first computer system (e.g., 300) and the second computer system, wherein physically moving the camera of the one or more cameras occurs in response to detecting the request to connect (e.g., as described above with respect to FIG. 3B).

In some embodiments, physically moving the camera of the one or more cameras includes panning, tilting, rotating, or any combination thereof (e.g., 1-360 degrees) via the movement component (e.g., as described above with respect to FIG. 3B).

In some embodiments, physically moving the camera of the one or more cameras includes changing, via the movement component, a location of the first computer system (e.g., 300) from a first location (e.g., coordinate) to a second location different from the first location (e.g., with or without changing an orientation of the first computer system) (e.g., as described above with respect to FIGS. 3B).

In some embodiments, physically moving the camera of the one or more cameras includes: in accordance with a determination that the environment (e.g., 330) is in a first state (e.g., includes a set of one or more features (e.g., objects and/or users) and/or a set of one or more features performing one or more particular actions, the computer system is unable to determine portions of the environment (e.g., a gap in the environment) (e.g., due to an obstruction blocking a portion of the environment)), physically moving the camera of the one or more cameras in a first direction (e.g., along an axis of rotation (e.g., clockwise, counterclockwise, forward, backward, left, and/or right)) (e.g., as described above with respect to FIG. 3B); and in accordance with a determination that the environment (e.g., 330) is in a second state different from the first state, physically moving the camera of the one or more cameras in a second direction different from the first direction (and/or without moving in the first direction) (e.g., as described above with respect to FIG. 3B).

In some embodiments, the first representation includes a portion of the environment (e.g., non-static, live, and/or foreground portion of the environment (e.g., a user of the first computer system and/or an animal in the environment)) that the second representation does not include (e.g., as described above with respect to FIG. 3D, the static representation of physical environment 330 and/or the media captured by the camera). In some embodiments, after capturing the first representation of the portion of the environment, the first computer system generates the second representation of the portion of the environment. In some embodiments, generating the second representation of the portion of the environment includes removing the portion of the environment that the second representation does not include (and/or forgoing including, in the second representation, the portion of the environment that the second representation does not include).

In some embodiments, the one or more cameras has (and/or captures) a first field-of-view. In some embodiments, the first representation of the portion of the environment has (and/or captures) a larger field-of-view than the first field-of-view (e.g., the first representation includes media captured by the one or more cameras at different positions (e.g., while physically moving the camera) such that the first representation includes more of the environment that is able to be captured by the one or more cameras without physically moving the camera) (e.g., as described above with respect to FIG. 3B). In some embodiments, the first representation is a combination of multiple pieces of media (e.g., stitched together and/or otherwise combined) to cover more area than the one or more cameras is able to capture without moving.

In some embodiments, in conjunction (e.g., before, after, in response to, and/or while) with sending, to the second computer system via the communication session, the second representation of the portion of the environment, the first computer system sends, via the communication session, a third representation (e.g., non-static, live, and/or foreground portion of the environment (e.g., a user of the first computer system and/or an animal in the environment)) of the portion of the environment different from the first representation and the second representation (e.g., as described with respect to FIG. 3D, the static representation of physical environment 330 and/or the media captured by the camera). In some embodiments, the first representation includes the third representation. In some embodiments, the second representation does not include the third representation. In some embodiments, the third representation is removed from the first representation to generate the second representation. In some embodiments, in conjunction (e.g., before, after, in response to, and/or while) with sending, to the second computer system via the communication session, the second representation of the portion of the environment, capturing, via the one or more cameras, the third representation of the portion of the environment.

In some embodiments, the second representation of the portion of the environment is sent via a first data transmission method (e.g., communication channel, protocol (e.g., Bluetooth, and/or Wi-Fi) and/or bit rate). In some embodiments, the third representation of the portion of the environment is sent via a second data transmission method different from the first data transmission method (e.g., as described above with respect to FIG. 3D).

Note that details of the processes described above with respect to method 400 (e.g., FIG. 4) are also applicable in an analogous manner to other methods described herein. For example, method 600 optionally includes one or more of the characteristics of the various methods described above with reference to method 400. For example, the directing the input devices to the user in method 600 can occur while sending the second representation of method 400. For brevity, these details are not repeated herein.

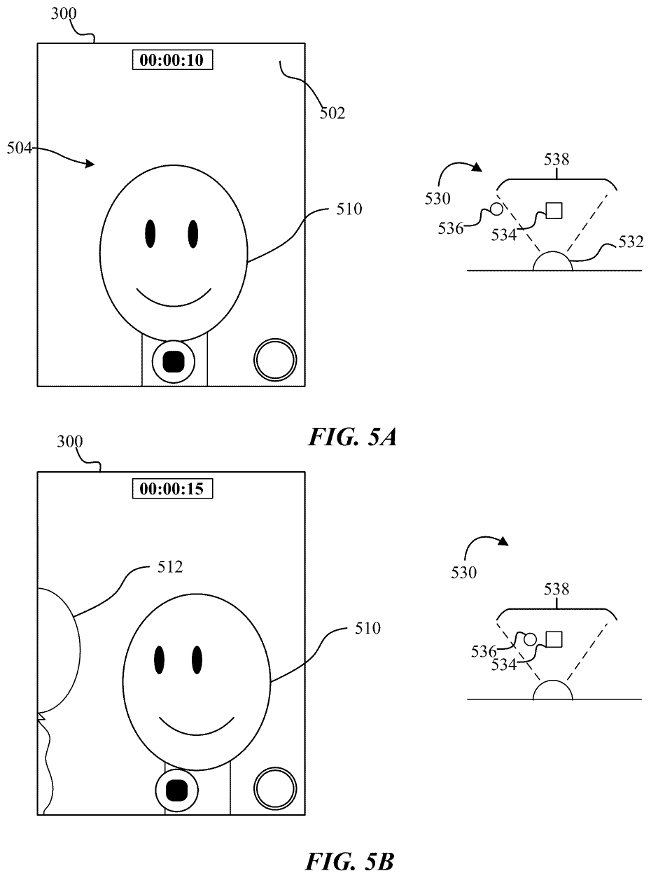

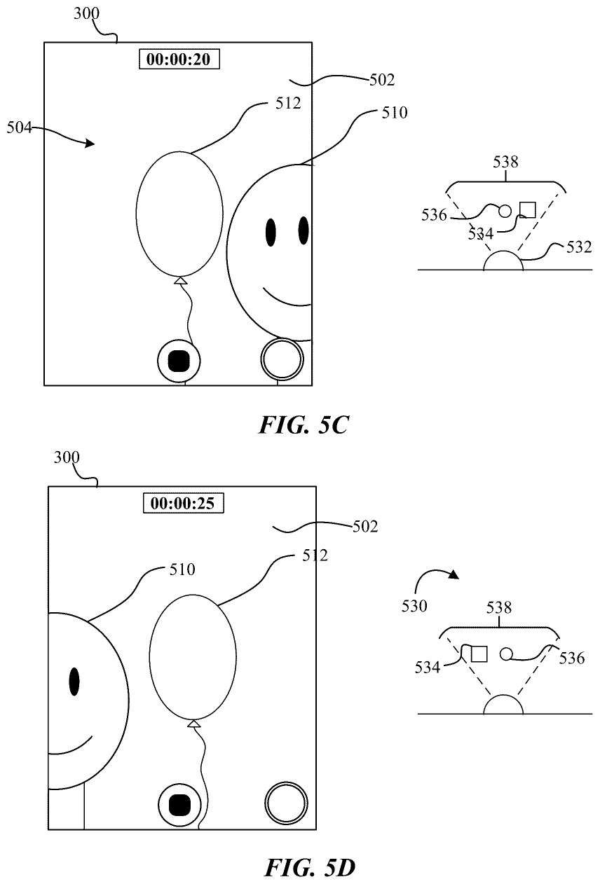

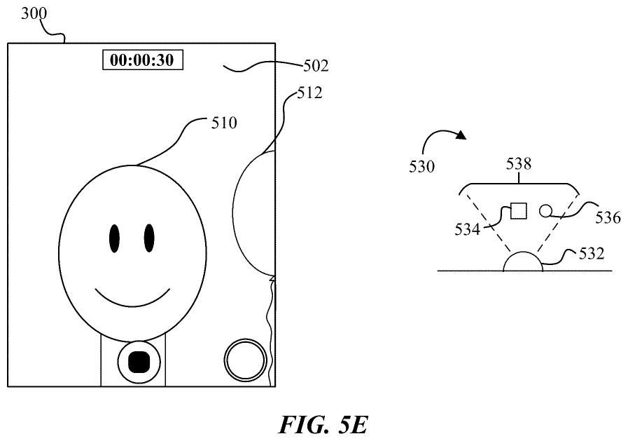

FIGS. 5A-5E illustrate exemplary user interfaces for capturing content while moving using a computer system in accordance with some embodiments. The user interfaces in these figures are used to illustrate the processes described below, including the processes in FIG. 6.

As illustrated on the right side in FIGS. 5A-5E, physical environment 530 includes different positions of computer system 300. Physical environment 530 includes device representation 532 (which represents a location of computer system 300 within physical environment 530), user representation 534 (which represents a location of user 510 within physical environment 530), and object representation 536 (which represents a location of balloon 512 within physical environment 530). As illustrated in FIGS. 5A-5E, physical environment 530 also includes field-of-view 538, which represents an orientation of computer system 300 within physical environment 530. In some embodiments, field-of-view 538 represents a field-of-view of a camera of computer system 300.

In some embodiments, computer system 300 pans, tilts, moves, and/or rotates the camera (and/or a portion of computer system 300) to capture a portion of and/or the entirety of physical environment 530. For example, computer system 300 can cause field-of-view 538 to be moved by activating a component of computer system 300, such as an actuator that is part of computer system 300, where movement of the actuator causes field-of-view 538 to be changed and/or shifted. In such an example, the actuator can move a portion of computer system 300 that includes the camera to a different direction and/or to be oriented differently so that field-of-view 538 is changed. For another example, computer system 300 can cause field-of-view 538 to be moved by activating a component remote and/or separate from computer system 300, such as an actuator of a mount physically and/or magnetically coupled to computer system 300. In such an example, computer system 300 can be in communication with the mount and controlling a position of the mount by sending control messages to the mount. It should be recognized that other techniques known by a person of ordinary skill in the art can be used in addition to or instead of techniques described above to result in moving field-of-view 538.

As illustrated on the left side of FIGS. 5A-5E, computer system 300 displays user interface 502. At FIGS. 5A-5E, user interface 502 is a user interface displayed by computer system 300 when computer system 300 is recording a video. At FIGS. 5A-5E, computer system 300 is recording a video review of balloons. In some embodiments, user interface 502 is displayed in response to computer system 300 detecting a request to capture media. It should be recognized that user interface 502 is just one example of a user interface used with techniques described herein and that other types of user interfaces can also be used. For example, although the below example describes recording a video, similar embodiments may be used for taking photos.

As illustrated in FIGS. 5A-5E, user interface 502 includes live view 504 in a center position of user interface 502. In some embodiments, live view 504 is displayed across the entirety of user interface 502. In some embodiments, live view 504 is displayed on the bottom or top of user interface 502. In some embodiments, live view 504 is a representation (e.g., an image or a video) of physical environment 530 as captured by the camera in communication with computer system 300. As illustrated in FIGS. 5A-5E, the representation includes user 510.

As illustrated in FIGS. 5A-5E, computer system 300 is directing the camera towards a subject (e.g., balloon 512 in FIGS. 5C-5D or user 510 in FIGS. 5A-5B and 5E). At FIGS. 5A-5E, directing the camera includes following a subject. For example, computer system 300 directs the camera to the subject by directing the camera to move to the subject and maintain a threshold distance from the subject. In some embodiments, directing the camera to a subject includes moving towards the subject. For example, computer system 300 directs the camera to move to a location nearby the subject. In another example, computer system 300 directs the camera to move in the direction of the current position of the subject. In some embodiments, directing towards a subject includes computer system 300 moving the camera towards a location of the subject. For example, the location of the subject can be a location adjacent to the subject.

In some embodiments, directing the camera to a subject includes maintaining a continuous view of the subject. For example, computer system 300 keeps the subject in field-of-view 538 of the camera by directing the camera to move to a corresponding location. In some embodiments, while directing to a subject, the subject becomes obstructed from view of the camera, such as by an obstacle. In such embodiments, computer system 300 can direct the camera to move around the obstacle to maintain and/or restore the subject in live view 504.

In some embodiments, computer system 300 includes components that enable computer system 300 to physically move in physical environment 530 (e.g., components described above in FIG. 3A). For example, computer system 300 can includes components that enable computer system 300 to move and/or move the camera of computer system 300.

As illustrated in FIG. 5A, user representation 534 is in field-of-view 538 in physical environment 330 and object representation 536 is outside of field-of-view 538 in physical environment 330. At FIG. 5A, device representation 532 is directing the camera of computer system 300 to user representation 534. In some embodiments, computer system 300 is directing the camera to user representation 534 in response to computer system 300 detecting an input to direct the camera towards user 510. For example, user 510 may provide a voice input (e.g., “please follow me”). In another example, user 510 provides a gesture (e.g., a hand wave) to direct the camera of computer system 300 towards user 510. In another example, user 510 provides a tap input on user interface 502 to direct the camera of computer system 300 towards user 510. At FIG. 5A, user representation 534 is moving to the left towards object representation 536. In some embodiments, computer system 300 identifies user 510 as the subject for the camera to be directed towards. In some embodiments, computer system 300 identifies user 510 as the subject by determining audio inputs originate from user 510. In some embodiments, computer system 300 identifies user 510 as the subject by determining user 510 is looking (e.g., a focus direction of user 510) towards computer system 300.

As illustrated in FIG. 5A, as computer system 300 directs the camera to user 510, computer system 300 captures media of user 510 while displaying the media (e.g., in live view 504). As illustrated in FIG. 5A, user 510 is in the center of live view 504. In some embodiments, while computer system 300 directs the camera to user 510, computer system 300 changes the frame and/or perspective of user 510 in live view 504. In some embodiments, computer system 300 changes the frame and/or perspective of user to zoom out and/or display user 510 to the right side of the frame in order to illustrate the movement. At FIG. 5A, because user 510 is moving to the left, computer system 300 displays the corresponding video captured by the camera of computer system 300 of user 510 on live view 504 moving to the left.

At FIG. 5B, in response to user 510 moving to the left, computer system 300 continues to direct the camera to user 510 and moves with user 510. As illustrated in FIG. 5B, user representation 534 remained in field-of-view 538 in physical environment 330 and object representation 536 is inside of field-of-view 538.

At FIG. 5B, in response to user 510 moving to the left, computer system 300 moves the camera with user 510 towards balloon 512. In some embodiments, computer system 300 maintains the composition of user 510 in live view 504. For example, in FIG. 5A, user 510 is centered on live view 504. In some embodiments, computer system 300 directs the camera to maintain the composition by directing the camera to move with user 510 to keep them centered in live view 504. In some embodiments, maintaining the composition of the camera includes maintaining the framing of the video. For example, if computer system 300 detects the framing is an establishing shot, computer system 300 directs the camera to positions that maintain the establishing shot framing. In another example, if computer system 300 detects the framing is a close up shot, computer system 300 directs the camera to positions that maintain the close up shot framing.

At FIG. 5B, computer system 300 determines that user 510 intends to change the subject from user 510 to balloon 512. In some embodiments, such a determination is performed based on detecting that the gaze of user 510 is directed towards balloon 512. For example, computer system 300 can detect that user 510 looks towards balloon 512 for a threshold period of time (e.g., 1-10 seconds). For another example, computer system 300 can detect that user 510 looks toward balloon 512 a threshold number of times (e.g., 2 or more). For another example, computer system 300 can detect that the gaze of user 510 meets a threshold intensity on balloon 512, such as by opening eye lids more and/or moving the head of user 510 towards balloon 512 while gazing at balloon 512. In other embodiments, such a determination is performed based on detecting a touch input by user 510 while the gaze of user 510 is directed towards balloon 512. In other embodiments, such a determination is performed based on detecting a voice input that refers to balloon 512. At FIG. 5B, in response to determining that user 510 intends to change the subject from user 510 to balloon 512, computer system 300 ceases directing the camera towards user 510 and directs the camera towards balloon 512.

At FIG. 5C, in response to computer system directing the camera towards balloon 512, computer system 300 directs the camera to move to center balloon 512 in live view 504. At FIG. 5C, while computer system 300 directs the camera towards balloon 512, computer system 300 (e.g., as represented by device representation 532) moved the camera to the left to center field-of-view 538 on object representation 536 instead of user representation 534.

At FIG. 5C, in response to computer system 300 directing the camera to move towards balloon 512, computer system 300 updated user interface 502 to display the updated view that is centered on balloon 512 with user 510 towards the right of user interface 502. In some embodiments, computer system 300 directs the camera to maintain the composition by directing the camera to move to center itself on balloon 512 in live view 504. For example, at FIG. 5C, computer system 300 directs the camera to maintain the zoom level and relative size of balloon 512 as the size of user 510 when computer system 300 detected the gaze of user 510 is on balloon 512. After FIG. 5C, user 510 moves to the left of balloon 512.

At FIG. 5D in response to user 510 moving to the left of balloon 512, computer system 300 maintains directing the camera to balloon 512. At FIG. 5D, because computer system 300 is directing the camera towards balloon 512, computer system 300 (e.g., as represented by device representation 532) does not direct the camera to move when user representation 534 moves in physical environment 530.

At FIG. 5D, in response to computer system 300 directing the camera to balloon 512, computer system 300 directs the camera to stay in place on balloon 512 centered on field-of-view 538. As illustrated in FIG. 5D, computer system 300 displays on user interface 502 user 510 on the left, reflecting the updated position of user 510 in physical environment 530.

As illustrated at FIG. 5D, user 510 is no longer gazing towards balloon 512 in physical environment 530. At FIG. 5D, computer system 300 detects user 510 no longer intends to change the subject from user 510 to balloon 512 by detecting that the gaze of user 510 is no longer directed towards balloon 512. In some embodiments, such detection occurs when user 510 looks away from balloon 512 for a threshold period of time (e.g., 1-10 seconds). In some embodiments, such detection occurs when computer system 300 detects a number of gazes not towards balloon 512. In some embodiments, such detection occurs when the gaze of user 510 no longer meets a threshold intensity on balloon 512. At FIG. 5D, in response to detecting that the gaze of user 510 is no longer directed towards balloon 512, computer system 300 ceases directing the camera towards balloon 512 and directs the camera towards user 510.

In some embodiments, computer system 300 ceases directing the camera towards balloon 512 in response to detecting a verbal input by user 510 (e.g., “follow me”). In some embodiments, computer system 300 ceases directing the camera towards balloon 512 in response to detecting a tap input on user interface 502.

At FIG. 5E, in response to detecting the gaze of user 510 is no longer directed towards balloon 512, computer system 300 directs the camera to user 510. At FIG. 5E on the right, in physical environment 530 computer system 300 moved the camera to user representation 534. At FIG. 5E on the left, user 510 is centered in live view 504.

In some embodiments, FIG. 5E illustrates an alternative embodiment where the gaze of user 510 was not directed to balloon 512 (e.g., user 510 looks towards balloon 512 for less than a threshold period of time) and computer system 300 determines user does not intend to change the subject from user 510 to balloon 512. In some embodiments, between FIGS. 5B and 5E, user 510 moved to the left of balloon 512. At FIG. 5E, in response to computer system 300 detecting the gaze of user 510 was not directed to balloon 512, computer system 300 continues to direct the camera to user 510. At FIG. 5E on the right, because user 510 moved to the left of balloon 612, user representation 534 moved to the left of object representation 536. At FIG. 5E, because computer system 300 directs the camera towards user 510, device representation 532 moves to keep user representation 534 in the center of field-of-view 538. At FIG. 5E on the left, in response to computer system 300 detecting gaze of user 510 is not directed to balloon 512 and user 510 moved to the left, computer system 300 displays user 510 in the center of user interface 502.

FIG. 6 is a flow diagram illustrating a method (e.g., method 600) for capturing content while moving in accordance with some embodiments. Some operations in method 600 are, optionally, combined, the orders of some operations are, optionally, changed, and some operations are, optionally, omitted.

As described below, method 600 provides an intuitive way for capturing content while moving. Method 600 reduces the cognitive burden on a user, thereby creating a more efficient human-machine interface. For battery-operated computing devices, enabling a user to interact with such devices faster and more efficiently conserves power and increases the time between battery charges.

In some embodiments, method 600 is performed at a computer system (e.g., 300) that is in communication (e.g., wired communication and/or wireless communication) with a movement component (e.g., an actuator (e.g., a pneumatic actuator, hydraulic actuator and/or an electric actuator), a movable base, a rotatable component, a motor, a lift, a level, and/or a rotatable base), and one or more input devices (e.g., a camera, a depth sensor, a microphone, a hardware input mechanism, a rotatable input mechanism, a heart monitor, a temperature sensor, and/or a touch-sensitive surface). In some embodiments, the computer system is a watch, a phone, a tablet, a fitness tracking device, a processor, a head-mounted display (HMD) device, a communal device, a media device, a speaker, a television, and/or a personal computing device. In some embodiments, the computer system is in communication with a mount. In some embodiments, the computer system is coupled (e.g., physical and/or magnetic) to the mount. In some embodiments, the mount includes the one or more input devices. In some embodiments, the mount includes the movement component.

While (602) capturing, via the one or more input devices, media content (e.g., one or more images, video, and/or HMD media) (e.g., 504), the computer system (e.g., 300) directs (604) (e.g., as described above with respect to FIGS. 5A-5E, computer system 300 directs a camera), via the movement component, the one or more input devices to (e.g., move towards, and/or follow) a user (e.g., 510) (e.g., a user of the computer system and/or a different user captured by the one or more input devices) (e.g., automatically, and/or in response to a request (e.g., an explicit request and/or user input directed to the computer system) by a user). In some embodiments, directing the one or more input devices to the user includes sending, to the mount, one or more instructions to physically move (e.g., pan, tilt, rotate and/or change physical position) via the movement component to the user. In some embodiments, the computer system initiates capturing the media content in response to the computer system detecting, via the one or more input devices, a request (e.g., an explicit request and/or user input directed to the computer system) (e.g., directed to the computer system) to capture the media content.

While (602) capturing, via the one or more input devices, media content, while directing the one or more input devices to the user (e.g., 510), the computer system detects (606), via the one or more input devices, a gaze of the user (e.g., 510) at a location (e.g., a position that the user is looking at and/or towards in the physical and/or virtual environment) (e.g., as described above with respect to FIG. 5B).

While (602) capturing, via the one or more input devices, media content, in response to (608) detecting the gaze of the user (e.g., 510) at the location, in accordance with a determination that the gaze of the user (e.g., 510) (and/or at the location) does not satisfy a set of one or more criteria (e.g., intensity of gaze, number of gazes, the gaze is detected with an additional input (e.g., verbal, touch, air gesture, tap, and/or click), and/or the gaze is at a location for more than a threshold period of time), the computer system continues (610) to direct, via the movement component, the one or more input devices to the user (e.g., as described above with respect to FIG. 5E).

While (602) capturing, via the one or more input devices, media content, in response to (608) detecting the gaze of the user at the location, in accordance with a determination that the gaze of the user (e.g., 510) (and/or at the location) satisfies the set of one or more criteria, the computer system directs (612) the one or more input devices to the location (and/or ceases to direct the one or more input devices to the user) (e.g., as described above with respect to FIGS. 5C-5D). In some embodiments, directing the one or more input devices to the location includes sending, to the mount, one or more instructions to physically move (e.g., pan, tilt, rotate and/or change physical position) via the movement component, to the location.

In some embodiments, directing the one or more input devices to the user (e.g., 510) includes physically moving (e.g., panning, tilting, rotating, and/or changing physical position) (and/or sending one or more instructions to the mount to physically move), via the movement component, the one or more input devices (and/or to a location corresponding to (e.g., within a predetermined and/or automatic distance from, and/or at a predetermined and/or automatic orientation (e.g., panning, tilting, and/or rotating) of) the user) (e.g., as described above with respect to FIGS. 5A-5E). In some embodiments, while directing the one or more input devices to the user and in accordance with a determination that the user is currently moving, the computer system moves the one or more input devices to the user and/or to maintain the user in a field of detection (e.g., a field-of-view or an area to audibly hear) of the one or more input devices. In some embodiments, while directing the one or more input devices to the user and in accordance with a determination the user is currently moving, the computer system sends the one or more instructions to the mount to move the one or more input devices to the user and/or to maintain the user in a field of detection (e.g., a field-of-view or an area to audibly hear) of the one or more input devices. In some embodiments, while directing the one or more input devices to the user and in accordance with a determination the user is not currently moving, the computer system forgoes moving the one or more input devices. In some embodiments, while directing the one or more input devices to the user and in accordance with a determination the user is not currently moving, the computer system forgoes sending the one or more instructions to the mount to move the one or more input devices.

In some embodiments, physically moving the one or more input devices includes: in accordance with a determination that an object (e.g., in a physical environment and/or a virtual environment) prevents the one or more input devices from directing the one or more input devices to the user (e.g., 510), physically moving (e.g., panning, tilting, rotating, and/or changing physical position) (and/or sending instructions to the mount to physically move), via the movement component, the one or more input devices to a position unobstructed by the object from directing the one or more input devices to the user (e.g., as described above with respect to FIG. 5D); and in accordance with a determination that an object does not prevent the one or more input devices from directing the one or more input devices to the user (e.g., 510), forgoing physically moving (and/or forgoing sending one or more instructions to the mount to physically move) the one or more input devices (e.g., to the position) (and/or continuing directing the one or more input devices to the user) (e.g., as described above with respect to FIG. 5D).

In some embodiments, directing the one or more input devices to the user (e.g., 510) includes maintaining a continuous view (e.g., via and/or captured by the one or more input devices) of the user (e.g., as described above with respect to FIGS. 5A-5E). In some embodiments, maintaining the continuous view of the user includes the computer system captures, via the one or more input devices, the user in a portion of a field-of-view of the one or more input devices while changing the orientation (e.g., tilt, pan, rotation, and/or position) of the computer system from the user.

In some embodiments, continuing to direct the one or more input devices to the user (e.g., 510) includes: in accordance with a determination that the user (e.g., 510) is in a first state (e.g., performing an action (e.g., gesturing and/or moving) and/or providing an input corresponding to an object and/or location), changing, via the movement component, a view (e.g., a frame and/or perspective captured via the one or more input devices) of the user (e.g., as described above with respect to FIG. 5A); and In some embodiments, changing the view of the user includes the computer system moves, via the movement component, from a first position (e.g., a particular location and/or orientation) that captures, via the one or more input devices, the user in a first portion of a field-of-view of the one or more input devices to a second position that captures, via the one or more input devices, the user in a second portion of a field-of-view of the one or more input devices different from the first portion of the field-of-view of the one or more input devices. in accordance with a determination that the user (e.g., 510) is in a second state different from the first state, forgoing change of the view of the user (e.g., as described above with respect to FIG. 5A).

In some embodiments, directing the one or more input devices to the location includes physically moving (e.g., panning, tilting, rotating, and/or changing physical position) (and/or sending instructions to the mount to move), via the movement component, the one or more input devices to a position (e.g., a particular location and/or orientation) corresponding to (e.g., to a position corresponding to (e.g., within a predetermined and/or automatic distance from, and/or at a predetermined and/or automatic orientation (e.g., pan, tilt, rotate)) from) (e.g., towards) the location (e.g., as described above with respect to FIGS. 5A-5E).

In some embodiments, the location corresponds to an object (e.g., a physical object, an object captured in the field-of-view of the one or more input devices) (e.g., 512), in a physical environment (e.g., 530) of the computer system (e.g., 300).

In some embodiments, after directing the one or more input devices to the location, the computer system detects (e.g., via the one or more input devices and/or by receiving, from another computer system different from the computer system, a notification of) an event (e.g., an input (e.g., a tap input and/or a non-tap input (e.g., a verbal input, an audible request, an audible command, an audible statement, a swipe input, a hold-and-drag input, a gaze input, an air gesture, mouse movement, and/or a mouse click)), a request, an expiration of a time threshold, and/or a current time) (e.g., corresponding to the user and/or a location different from the location) (e.g., as described above with respect to FIG. 5E). In some embodiments, in response to detecting the event, the computer system directs, via the movement component, the one or more input devices (and/or sends one or more instructions to the mount to physically move) to the user (e.g., 510) (e.g., as described above with respect to FIGS. 5E).

Note that details of the processes described above with respect to method 600 (e.g., FIG. 6) are also applicable in an analogous manner to the methods described herein. For example, method 400 optionally includes one or more of the characteristics of the various methods described herein with reference to method 600. For example, sending the second representation of the environment of method 400 can occur while capturing media content of method 600. For brevity, these details are not repeated herein.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the techniques and their practical applications. Others skilled in the art are thereby enabled to best utilize the techniques and various examples with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve content capture. The present disclosure contemplates that in some instances, this gathered data can include personal information data that uniquely identifies or can be used to contact or locate a specific person. Such personal information data can include photos, videos, demographic data, location-based data, telephone numbers, email addresses, home addresses, or any other identifying information.

The present disclosure recognizes that the use of such personal information data, in the present technology, can be used to the benefit of users. For example, the personal information data can be used to capture content of and/or fora user. Accordingly, use of such personal information data enables better content capture. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of image capture, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

1. A method, comprising:
at a first computer system that is in communication with a movement component, and one or more cameras:
connecting to a second computer system, different from the first computer system, via a communication session;
in conjunction with connecting to the second computer system via the communication session:
physically moving, via the movement component, a camera of the one or more cameras; and
while physically moving the camera, capturing, via the one or more cameras, a first representation of a portion of an environment; and
after capturing the first representation of the portion of the environment, sending, to the second computer system via the communication session, a second representation of the portion of the environment, wherein the second representation is based on the first representation of the portion of the environment, and wherein the second representation is different from the first representation.

2. The method of claim 1, wherein the first computer system is in communication with one or more input devices, the method further comprising:
before connecting to the second computer system via the communication session, detecting, via the one or more input devices, an input corresponding to a request to connect the first computer system and the second computer system, wherein physically moving the camera of the one or more cameras occurs in response to detecting the input corresponding to the request to connect.

3. The method of claim 1, further comprising:
before connecting to the second computer system via the communication session, detecting a request to connect the first computer system and the second computer system, wherein physically moving the camera of the one or more cameras occurs in response to detecting the request to connect.

4. The method of claim 1, wherein physically moving the camera of the one or more cameras includes panning, tilting, rotating, or any combination thereof via the movement component.

5. The method of claim 1, wherein physically moving the camera of the one or more cameras includes changing, via the movement component, a location of the first computer system from a first location to a second location different from the first location.

6. The method of claim 1, wherein physically moving the camera of the one or more cameras includes:
in accordance with a determination that the environment is in a first state, physically moving the camera of the one or more cameras in a first direction; and
in accordance with a determination that the environment is in a second state different from the first state, physically moving the camera of the one or more cameras in a second direction different from the first direction.

7. The method of claim 1, wherein the first representation includes a portion of the environment that the second representation does not include.

8. The method of claim 1, wherein the one or more cameras has a first field-of-view, and wherein the first representation of the portion of the environment has a larger field-of-view than the first field-of-view.

9. The method of claim 1, further comprising:
in conjunction with sending, to the second computer system via the communication session, the second representation of the portion of the environment, sending, via the communication session, a third representation of the portion of the environment different from the first representation and the second representation.

10. The method of claim 9, wherein the second representation of the portion of the environment is sent via a first data transmission method, and wherein the third representation of the portion of the environment is sent via a second data transmission method different from the first data transmission method.

11. (canceled)

12. (canceled)

13. (canceled)

14. (canceled)

15. A non-transitory computer-readable storage medium storing one or more programs configured to be executed by one or more processors of a first computer system that is in communication with a movement component, and one or more cameras, the one or more programs including instructions for:
connecting to a second computer system, different from the first computer system, via a communication session;
in conjunction with connecting to the second computer system via the communication session:
physically moving, via the movement component, a camera of the one or more cameras; and
while physically moving the camera, capturing, via the one or more cameras, a first representation of a portion of an environment; and
after capturing the first representation of the portion of the environment, sending, to the second computer system via the communication session, a second representation of the portion of the environment, wherein the second representation is based on the first representation of the portion of the environment, and wherein the second representation is different from the first representation.

16. A first computer system configured to communicate with a movement component, and one or more cameras, comprising:
one or more processors; and
memory storing one or more programs configured to be executed by the one or more processors, the one or more programs including instructions for:
connecting to a second computer system, different from the first computer system, via a communication session;
in conjunction with connecting to the second computer system via the communication session:
physically moving, via the movement component, a camera of the one or more cameras; and
while physically moving the camera, capturing, via the one or more cameras, a first representation of a portion of an environment; and
after capturing the first representation of the portion of the environment, sending, to the second computer system via the communication session, a second representation of the portion of the environment, wherein the second representation is based on the first representation of the portion of the environment, and wherein the second representation is different from the first representation.

17.-34. (canceled)
